(19) United States
(12) Patent Application Publication
(10) Pub. No.: US 2011/0148082 A1
(43) Pub. Date: Jun. 23, 2011

(54) METHOD AND DEVICE FOR ACTIVATING OCCUPANT PROTECTION MEANS

(76) Inventors: Armin Köhler, Sachsenheim (DE); Reiner Marchthaler, Gingen (DE); Hermann Schuller, Sindelfingen (DE)

(21) Appl. No.: 11/663,717

(22) PCT Filed: Aug. 5, 2005
(86) PCT No.: PCT/EP05/53867

§ 371 Date: Sep. 10, 2007

(30) Foreign Application Priority Data
Oct. 2, 2004 (DE) 10 2004 048 129.6

(51) Int. Cl. B60R 21/16

(52) U.S. Cl. 280/735

(57) ABSTRACT

In a method for activating occupant protection means as a function of at least one input quantity derived from at least one acceleration sensor, characteristic curves are calculated for the input quantities deceleration, forward displacement and/or speed reduction, which characteristic curves define at least one area in a quadrant of a coordinate system, which determines the deployment behavior of the occupant protection means.

### BACKGROUND OF THE INVENTION

1. Field of the Invention

The present invention is directed to a method for activating occupant protection means.

2. Description of Related Art

Deployment algorithms for occupant protection means nowadays utilize different characteristic curves, which are used to make a distinction between crash types for which occupant protection means are to be deployed and those for which they are not, in as timely a manner as possible.

Published European patent document EP 458 796 describes a method for activating occupant protection means in which a variable threshold for an integrated acceleration value is set as a function of parameters characterizing the crash sequence. The crash sequence and thus the crash type and the crash severity can thus be very accurately analyzed. In particular, the variable threshold is determined as a function of the acceleration, and the speed reduction is checked against this threshold.

### A BRIEF SUMMARY OF THE INVENTION

The method according to the present invention for activating occupant protection means has the advantage over the related art that characteristic curves are calculated for the input quantities deceleration and/or forward displacement and/or speed reduction, these characteristic curves defining at least one area in a quadrant of a coordinate system, which determines the deployment behavior of the occupant protection means. The risk for occupant injuries may thus be reduced if the occupant has already positioned him/herself too close to the occupant protection means such as an airbag, for example. The method according to the present invention makes it possible to adapt the deployment behavior of the occupant protection means optimally to a measured or estimated occupant position.

Occupant protection means may thus be deployed, for example, with full protection effect within a first area and/or with a limited protection effect within a second area and/or not be deployed in a third area, the currently applicable area being determined by comparisons of the currently ascertained input quantities with predefined threshold values.

It is advantageous that a first characteristic curve of the input quantities forward displacement and deceleration and/or a second characteristic curve of the input quantities speed reduction and deceleration are used to distinguish between erroneous deployment events and crash cases.

If a crash situation has been recognized, an optimum deployment point in time is advantageously determined for the occupant protection means via further comparisons of the currently ascertained input quantities with further threshold values.

The device according to the present invention for carrying out the method for deploying occupant protection means includes an acceleration sensor system, an analyzing and control unit, and a deployment unit; the analyzing and control unit receives and analyzes the signals of the acceleration sensor system for activating the deployment unit for the occupant protection means, determines the instantaneous input quantities forward displacement, deceleration, and/or speed reduction, and compares them with at least one defined area, which determines

### BACKGROUND OF THE INVENTION

1. Field of the Invention

The present invention is directed to a method for activating occupant protection means.

2. Description of Related Art

Deployment algorithms for occupant protection means nowadays utilize different characteristic curves, which are used to make a distinction between crash types for which occupant protection means are to be deployed and those for which they are not, in as timely a manner as possible.

Published European patent document EP 458 796 describes a method for activating occupant protection means in which a variable threshold for an integrated acceleration value is set as a function of parameters characterizing the crash sequence. The crash sequence and thus the crash type and the crash severity can thus be very accurately analyzed. In particular, the variable threshold is determined as a function of the acceleration, and the speed reduction is checked against this threshold.

### A BRIEF SUMMARY OF THE INVENTION

The method according to the present invention for activating occupant protection means has the advantage over the related art that characteristic curves are calculated for the input quantities deceleration and/or forward displacement and/or speed reduction, these characteristic curves defining at least one area in a quadrant of a coordinate system, which determines the deployment behavior of the occupant protection means. The risk for occupant injuries may thus be reduced if the occupant has already positioned him/herself too close to the occupant protection means such as an airbag, for example. The method according to the present invention makes it possible to adapt the deployment behavior of the occupant protection means optimally to a measured or estimated occupant position.

Occupant protection means may thus be deployed, for example, with full protection effect within a first area and/or with a limited protection effect within a second area and/or not be deployed in a third area, the currently applicable area being determined by comparisons of the currently ascertained input quantities with predefined threshold values.

It is advantageous that a first characteristic curve of the input quantities forward displacement and deceleration and/or a second characteristic curve of the input quantities speed reduction and deceleration are used to distinguish between erroneous deployment events and crash cases.

If a crash situation has been recognized, an optimum deployment point in time is advantageously determined for the occupant protection means via further comparisons of the currently ascertained input quantities with further threshold values.

The device according to the present invention for carrying out the method for deploying occupant protection means includes an acceleration sensor system, an analyzing and control unit, and a deployment unit; the analyzing and control unit receives and analyzes the signals of the acceleration sensor system for activating the deployment unit for the occupant protection means, determines the instantaneous input quantities forward displacement, deceleration, and/or speed reduction, and compares them with at least one defined area, which determines the deployment behavior of the occupant protection means, the at least one area being defined by characteristic curves in a quadrant of a coordinate system which are computed for the input quantities deceleration and/or forward displacement and/or speed reduction.

In a particularly advantageous example embodiment, the occupant protection means are designed as a two-stage airbag, which is activated with full protection effect by the analyzing and control unit via the deployment unit if a first area is determined via a comparison of the instantaneous input quantities with predefined threshold values; the analyzing and control unit activates only a first stage of the airbag if a second area is determined via the comparison, and the analyzing and control unit does not deploy the airbag if a third area is determined via the comparison.

It is furthermore advantageous that the analyzing and control unit uses additional signal data from an upfront sensor system and/or from an environment sensor system and/or from a seat occupancy sensor and/or from a side impact sensor system to ascertain the instantaneous area for the required deployment behavior.

In a further advantageous example embodiment, the method according to the present invention for deploying occupant protection means is implemented as software able to run on a microprocessor in a control unit.

### BRIEF DESCRIPTION OF THE SEVERAL VIEWS OF THE DRAWING

FIG. 1 shows a block diagram of the device according to the present invention.

FIG. 2 schematically shows the deployment areas defined by the characteristic curves.

### DETAILED DESCRIPTION OF THE INVENTION

Deployment algorithms for activating occupant protection systems are essentially based on signals obtained via acceleration sensors. Signals from environmental sensors, pressure sensors, in particular for side impact sensing, and signals from seat occupancy sensors may also be used. The acceleration sensors may be situated in the control unit, which is usually located in the area of the transmission tunnel, or may also serve as side impact sensors or front impact sensors. Front impact sensors are usually attached to the radiator grill, while the side impact sensors are situated in the B pillar or the transverse seat support. The acceleration signals may be compared with a noise threshold, for example, to suppress harmless vibrations such as caused by potholes, for example, or other events. This results in uncertainties in defining the crash start. It has been proposed to configure the deployment algorithm as a function of time. This may be achieved, for example, by defining a threshold value plane via pairs of deceleration, speed reduction, and forward displacement values. This threshold value plane is then compared with the forward displacement resulting from the measured values. If the threshold value plane is broken through, touched, or intersected, a crash requiring deployment of occupant protection means may be assumed. The threshold value plane may be modified as a function of characteristic values such as crash severity or crash type, as well as signals of external sensors such as upfront, pre-crash, or side impact sensors to adaptively respond to the particular circumstances.

It is provided according to the present invention that, in order to activate the occupant protection means, characteristic curves be computed from the input quantities deceleration and/or forward displacement and/or speed reduction, which are derived from at least one input quantity of at least one acceleration sensor; these characteristic curves define at least one area in a quadrant of a coordinate system, which determines the deployment behavior of the occupant protection means.

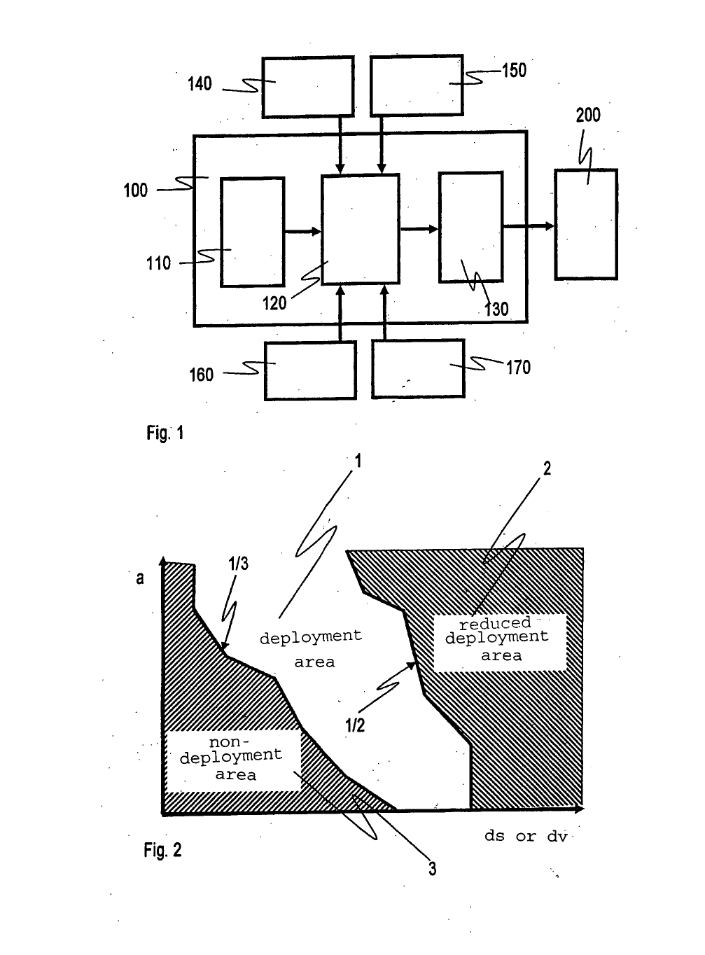

FIG. 1 shows a device for carrying out the method according to the present invention. A control unit 100 has an analyzing and control unit 120 which is designed, for example, as a microcontroller or microprocessor, etc., whose first data input is connected to an acceleration sensor system 110, which is located within control unit 100. Acceleration sensor system 110 measures, for example, in the longitudinal and transverse directions of the vehicle; the acceleration sensors may also be situated at predefined angles to the longitudinal and transverse directions of the vehicle. Analyzing and control unit 120 is connected to a deployment unit 130 via a first data output, the deployment unit being designed as an ignition circuit module, for example, and being used for igniting ignition elements of occupant protection means 200. Further details within control unit 100, such as a voltage supply, etc., are omitted here for the sake of simplicity. Deployment unit 130 is connected to occupant protection means 200 via an output. An upfront sensor system 140 is connected to a second data input of analyzing and control unit 120. Upfront sensor system 140 may include acceleration sensors which are attached to the radiator grill, for example. A side impact sensor system 170, which may also include acceleration sensors and/or pressure sensors and is located in the B pillar or in the vehicle door, for example, is connected to a third data input of analyzing and control unit 120. A seat occupancy sensor system 160 is connected to a fourth data input of the analyzing and control unit. Seat occupancy sensor system 160 may recognize seat occupancy by measuring weight, for example, using dynamometric bolts or a seat mat, or an interior video sensor or an ultrasound or radar sensor may be used. An environment sensor system 150 is connected to a fifth data input of analyzing and control unit 120. Environmental sensor system 150 includes, for example, a combination of ultrasound sensors, radar sensors, and/or video sensors, and/or a pedestrian protection contact sensor system. To carry out the method according to the present invention, analyzing and control unit 120 receives signals a of acceleration sensor system 110, which are integrated to obtain a speed reduction Δv; further integration yields forward displacement Δs.

A characteristic curve having input quantities Δs or Δv and acceleration a is used for making a distinction between erroneous deployment events and crash cases. Furthermore, an optimum firing point in time may be determined via additional thresholds, which are compared to input quantities a, Δv, Δs. Different areas may be defined in a quadrant of a coordinate system with the help of further characteristic curves using the same input quantities a, Δv, Δs. For example, in FIG. 2 a first characteristic curve ½ separates a first area 1 from a second area 2, and a second characteristic curve ⅓ separates the first area from a third area 3. Illustrated areas 1, 2, 3, each define a corresponding deployment behavior of occupant protection means 200. For example, if the occupant protection means include a two-stage airbag, airbag 200 is deployed with full protection effect if first area 1 is determined from the currently ascertained input quantities a, Δs, Δv via comparison with predefined threshold values, i.e., the first area represents full deployment of occupant protection means 200. If second area 2 is determined from the currently ascertained input quantities a, Δs, Δv via comparison with predefined threshold values, only the first stage of airbag 200 is deployed, i.e., the second area represents a partial deployment of occupant protection means 200. If third area 3 is determined from the currently ascertained input quantities a, Δs, Δv via comparison with predefined threshold values, airbag 200 is not deployed, i.e., deployment of occupant protection means 200 is prevented in the third area.

First area 1 is recognized, for example, if the distance between the occupant and airbag 200 is sufficiently large, and endangerment of the occupant due to the full deployment of the occupant protection means is unlikely. Second area 2 is recognized, for example, if full deployment of the occupant protection means would present an increased risk for the occupant and/or if the protection effect of the first stage of two-stage airbag 200 is sufficient for the recognized crash case. The second stage of the airbag is deployed via “disposal ignition” with a long delay in order to prevent endangerment of people, for example, when rescuing the injured. Third area 3 is recognized, for example, if deployment of the occupant protection means is not required due to the recognized severity of the crash and/or the recognized crash type.

The measured or estimated forward displacement is elucidated using an example below. For example, if a forward displacement of 50 cm is estimated and the maximum distance between the occupant's face and the fully inflated airbag is 45 cm, at the estimated point in time of impact on the airbag, i.e., the ascertained deployment point in time or ignition point in time plus time of inflation of the airbag, which is approximately 30 ms, the occupant is already so close to the airbag that full deployment must be prevented and the airbag is only partly deployed. The second area is thus determined in this case. If, for example, a forward displacement of 15 cm is estimated and the distance is as mentioned previously, in this case first area 1 may be determined, and two-stage airbag 200 may be fully deployed, i.e., including the second stage, or only partly deployed, i.e., with the first stage if the restraining effect of the first stage of two-stage airbag 200 is sufficient. Whether the first stage of two-stage airbag 200 is sufficient depends on the individual characteristics such as size, weight, etc., of the occupant, which are determined, for example, by seat occupancy sensor system 160 and/or the interior video sensor system.

The occupant is appropriately protected by the method according to the present invention. If, at the point of time of ignition, the occupant is too close to the restraining means, ignition of airbag 200 may be suppressed by extending the characteristic curve or the airbag may be prevented from deploying with full effect (depowered) using adjusted ignition.

1-8. (canceled)

9. A method for activating an occupant protection device of a vehicle, comprising:
detecting a value of at least one input quantity derived from at least one acceleration sensor;
calculating at least one characteristic curve associated with the at least one input quantity, wherein the at least one input quantity includes at least one of deceleration, forward displacement and speed reduction, and wherein the at least one characteristic curve defines at least two characteristic areas in a quadrant of a coordinate system at least partly defined by the at least one input quantity; and
selectively controlling a deployment behavior of the occupant protection device depending on which of the at least two characteristic areas includes the detected value of the at least one input quantity.

10. The method as recited in claim 9, wherein the at least one characteristic curve defines at least three characteristic areas in the quadrant of the coordinate system, and wherein the selective control of the deployment behavior of the occupant protection device includes one of: a) deployment with full protection effect if the detected value of the at least one input quantity is within a first characteristic area; b) deployment with limited protection effect if the detected value of the at least one input quantity is within a second characteristic area; and c) no deployment if the detected value of the at least one input quantity is within a third characteristic area, and wherein the location of the detected value of the at least one input quantity within the quadrant of the coordinate system is determined by comparing the detected value of the at least one input quantity with a predefined corresponding threshold value.

11. The method as recited in claim 10, wherein at least one of: a) a first characteristic curve of forward displacement and deceleration; and b) a second characteristic curve of speed reduction and deceleration, is used to distinguish between a situation not requiring a deployment of the occupant protection device and a crash situation requiring a deployment of the occupant protection device.

12. The method as recited in claim 11, wherein, if a crash situation has been recognized, an optimum deployment point in time is determined for the occupant protection device by comparison of the detected value of the at least one input quantity with at least one further threshold value.

13. A device for controlling activation of an occupant protection device of a vehicle, comprising:
an acceleration sensor system;
an analyzing and control unit connected to the acceleration sensor system; and
a deployment unit connected to the analyzing and control unit;
wherein the analyzing and control unit receives and analyzes signals of the acceleration sensor system to determine an instantaneous value of at least one input quantity including at least one of forward displacement, deceleration and speed reduction, and wherein the analyzing and control unit compares the determined instantaneous value of the at least one input quantity with a quadrant of a coordinate system including at least two areas defined by at least one characteristic curve associated with the at least one input quantity, and wherein the analyzing and control unit selectively controls a deployment behavior of the occupant protection device depending-on which of the at least two characteristic areas includes the determined instantaneous value of the at least one input quantity.

14. The device as recited in claim 13, wherein the occupant protection device is a two-stage airbag, and wherein the at least one characteristic curve defines at least three characteristic areas in the quadrant of the coordinate system, and wherein the selective control of the deployment behavior of the occupant protection device includes one of: a) deployment with full protection effect if the determined instantaneous value of the at least one input quantity is within a first characteristic area; b) deployment with limited protection effect if the determined instantaneous value of the at least one input quantity is within a second characteristic area; and c) no deployment if the determined instantaneous value of the at least one input quantity is within a third characteristic area, and wherein the location of the determined instantaneous value of the at least one input quantity within the quadrant of the coordinate system is determined by comparing the determined instantaneous value of the at least one input quantity with a predefined corresponding threshold value.

15. The device as recited in claim 13, wherein the analyzing and control unit further utilizes signal data from at least one of: a) a front sensor system; b) an environment sensor system; c) a seat occupancy sensor system; and d) a side impact sensor system.

16. A computer-readable storage medium for storing a computer program configured to control, when executed on a computer, a method for activating an occupant protection device of a vehicle, the method comprising:
detecting a value of at least one input quantity derived from at least one acceleration sensor;
calculating at least one characteristic curve associated with the at least one input quantity, wherein the at least one input quantity includes at least one of deceleration, forward displacement and speed reduction, and wherein the at least one characteristic curve defines at least two characteristic areas in a quadrant of a coordinate system at least partly defined by the at least one input quantity; and
selectively controlling a deployment behavior of the occupant protection device depending on which of the at least two characteristic areas includes the detected value of the at least one input quantity.
